(19) United States
(12) Patent Application Publication
(10) Pub. No.: US 2003/0204708 A1
(43) Pub. Date: Oct. 30, 2003

(54) Portable computer having hierarchical operating systems

(76) Inventors: Colin Hulme, Hillsboro, OR (US); Gary Haycox, Beaverton, OR (US)

Correspondence Address: James A. Flight, Grossman & Flight, LLC, 20 North Wacker Drive, Suite 4220, Chicago, IL, 60606, US

(21) Appl. No.: 10/131,114

(22) Filed: Apr. 24, 2002

(51) Int. Cl. G06F 15/177

(52) U.S. Cl. 713/1

(57) ABSTRACT

A portable computer is disclosed which includes hierarchical operating systems. The computer includes a handheld operating system to operate the portable computer as a handheld device. It also includes a laptop operating system to operate the portable computer as a laptop computer. The laptop operating system is responsive to a first command to boot-up the handheld operating system. The handheld operating system is responsive to a second command to boot-up the laptop operating system.

### FIELD OF THE INVENTION

The invention relates generally to portable computers, and, more particularly, to a portable computer having hierarchical operating systems.

### BACKGROUND OF THE INVENTION

Personal digital assistants (“PDA's”) and other handheld computers have become increasingly popular in recent years. These handheld computers include a handheld operating system (e.g., Windows CE) that controls the operation of the computer to provide a handheld operating environment in which the user can execute various handheld applications (e.g., an electronic calendar, an electronic contact address, an electronic telephone list, an electronic “To Do” list, a calculator, an e-mail viewer, a web browser, etc.) and enter/retrieve handheld data (e.g., physical mailing addresses, e-mail addresses, telephone numbers, names, events in a calendar or schedule, tasks, web pages, e-mail texts, etc.). Such handheld computers are microprocessor based (frequently using a reduced instruction set (RISC) processor) and frequently include on-board read-only and random access memory, a communication device (e.g., a modem, a cell phone, etc.), an input device (e.g., a touchscreen), an output device (e.g., a touchscreen, a liquid crystal display LCD)) and a battery (e.g., a lithium ion rechargeable battery). The computing power and memory resources of these handheld computers are typically limited, but have been increasing. Some of these handheld computers have also been increasing in physical size to, for example, accommodate a keyboard and/or a Video Graphics Array (VGA) resolution display screen.

Laptop and notebook computers and other portable machines (referred to herein collectively and interchangeable as “laptop computers”) capable of executing a laptop operating system (e.g., Windows XP, Macintosh OSX, etc.) have also increased in popularity in recent years. Laptop computers have increased in computing power and decreased in physical size over the years. Laptop computers typically include a microprocessor, an input device (e.g., a keyboard, a mouse, a trackball), an output device (e.g., a liquid crystal display), random access and read-only memories, one or more mass storage devices (e.g., a floppy disk drive, a hard disk drive, an optical disk drive (e.g., a compact disk (CD) drive, a digital versatile disk (DVD) drive), a communication device (e.g., a modem, a network interface card, etc.), and a rechargeable battery. Laptop computers operate a laptop operating system, that controls the operation of the computer to provide a laptop operating environment in which the user can execute various laptop applications (e.g., a word processor, a web browser, a spreadsheet, etc.) and enter/retrieve data.

Laptop computers and handheld computers both enjoy advantages with respect to one another. For example, handheld computers are advantageous with respect to laptop computers in that handheld computers enjoy longer battery life, handheld computers wake in response to alarms (e.g., a scheduled event), and handheld computers turn on very quickly. On the other hand, laptop computers are advantageous with respect to handheld computers in that they provide a more powerful operating environment (e.g., a faster processor, higher speed and larger memory, increased disk space and access to a wider range of peripherals), and they execute legacy software (e.g., Windows applications). Existing handheld computers cannot run legacy software without using an emulator. Thus, while the physical sizes of handheld computers and laptop computers have begun to converge, they both retain certain advantages and disadvantages making it desirable or even necessary for some users to purchase and maintain both a handheld computer and a laptop.

Some known computers allow installing multiple operating systems and partitioning of the hard drive between such systems. In such computers, the user is prompted at boot time to select which operating system to load. Thus, the operating systems are on the same machine, but they are not hierarchically related and cannot call one another.

Known technology is also available for running a second operating system in a virtual machine under a primary operating system. This is similar to Microsoft's approach to running DOS in a virtual machine under Windows. VMWARE is a company offering this functionality for Linux and Windows NT.

### BRIEF DESCRIPTION OF THE DRAWINGS

FIG. 1 is a perspective view of an example portable computer constructed in accordance with the teachings of the invention.

FIG. 2 is a block diagram of the portable computer of FIG. 1.

FIG. 3 is a block diagram of an example power supply for the portable computer of FIG. 1.

FIG. 4 is a flow diagram illustrating some example operating states of the portable computer of FIG. 1.

FIGS. 5A-5C are a flowchart illustrating an example software program executed by the portable computer of FIG. 1.

FIG. 6 is a flowchart illustrating an example suspend routine for the example program of FIGS. 5A-5C.

### DESCRIPTION OF THE PREFERRED EXAMPLES

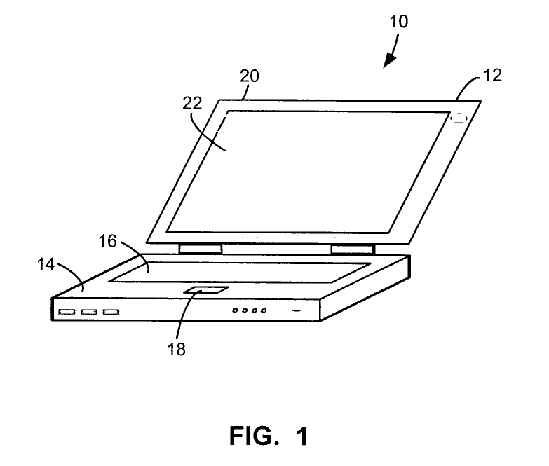

FIG. 1 is a perspective view of an example portable computer 10 constructed in accordance with the teachings of the invention. As used herein “portable computer” refers to any computer (e.g., PDA, laptop computer, notebook computer, etc.) that is designed to be carried by a person. Although in the illustrated example, the portable computer 10 is shown as including a clam-shell type housing 12 frequently associated with laptop and notebook computers, persons of ordinary skill in the art will appreciate that any other housing that is amenable to being carried by a person could alternatively be employed. For example, although the illustrated housing 12 includes (a) a base 14 containing input devices such as a keyboard 16 and touchpad 18, and (b) an upper display section 20 containing an LCD display 22 and hinged to the base 14 for closing the housing for transport in conventional fashion, persons of ordinary skill in the art will appreciate that a one piece housing (e.g., the housing typically used for a PDA such as the Palm Pilot™) or any other type of housing could alternatively be employed.

As explained in detail below, the illustrated portable computer 10 is a modified laptop computer which is programmed to provide hierarchically related operating environments. More specifically, the illustrated computer 10 includes a handheld operating system (e.g., Windows CE), which operates the portable computer 10 as a handheld device (e.g., a PDA), and a laptop operating system (e.g., Windows XP) which operates the portable computer 10 as a laptop computer. In the illustrated example, the laptop operating system responds to a command to power down by (1) shutting down in a conventional fashion, and (2) by booting up the handheld operating system rather than entering a true powered off state. When the handheld operating system is booted up in this fashion, all of the standard handheld features, (i.e., software and applications and handheld data) of that handheld operating environment are available. In addition, the handheld operating system is modified to respond to a command to boot-up the laptop operating system by (1) shutting itself down and then (2) initiating the boot-up process for the laptop operating system. For example, the handheld operating system (e.g., Windows CE) is configured to include a user selectable option to boot up the laptop operating system (e.g., in Windows CE, pressing the “start” button reveals an additional choice such as “Boot Windows XP”.) When the laptop operating system is booted up, all of the standard laptop features. (e.g., laptop software, data and hardware) of the laptop operating environment are available. Typically, a set of hardware features (e.g., CD access, DVD access, hardware access) are available in the laptop operating environment that are unavailable in the handheld operating environment. Further details of the hierarchical relationship between the two operating systems are provided below.

The portable computer 10 of the instant example includes the conventional hardware components of a laptop or notebook computer and may optionally include modifications to that conventional construction as explained in detail below. Thus, as shown in FIG. 2, the portable computer 10 includes a central processing unit 30 which is implemented, for example, by one or more Intel®) microprocessors from the Pentium(family, the Itanium™ family or the XScale™ family.

In the illustrated example, the microprocessor 30 employs Intel's Geyserville (or analogous) technology or a modification thereof as explained below. Geyserville technology provides a processor with the ability to run in multiple different power modes which are selected based on whether power is supplied from an external power source (e.g., a commercial power source via an AC adapter) or whether power is supplied by an internal power source (e.g., a battery). The power consumption of a processor is directly proportional to V²F (where “V” is the supply voltage to the processor and “F” is the operating frequency of the processor). By reducing the voltage supplied to the processor and the operating frequency of the processor when the portable computer 10 is connected to the internal source (e.g., a battery), significant savings in power consumption are achieved which lengthens the possible operating time between charges possible when running on batteries.

As is conventional, the central processing unit 30 is in communication with a volatile memory 32 and a non-volatile memory 34 via a bus 36. The volatile memory may be implemented by SDRAM, DRAM, RAMBUS or any other type of random access memory device. The non-volatile memory 34 may be implemented by flash memory or any other desired type of memory device. Access to the memory 32 is typically controlled by a memory controller (not shown) in a conventional manner.

The portable computer 10 also includes a conventional interface circuit 38. The interface circuit 38 may be implemented by any type of well known interface standard, such as an Ethernet interface, and/or a universal serial bus (USB) and/or a third generation input/output (3GIO) interface.

One or more input devices 40 are connected to the interface circuit 38. The input device(s) 40 permit a user to enter data and commands into the CPU 30. The input device(s) can be implemented by, for example, a keyboard 16, a mouse, a touchscreen, a track-pad 18, a trackball, isopoint and/or a voice recognition system.

One or more output devices 42 are also connected to the interface circuit 38. The output devices 42 can be implemented, for example, by display devices (e.g., a liquid crystal display 22), a printer and/or speakers). The interface circuit 38 would, thus, typically include a graphics driver card.

The interface circuit 38 may also include a communication device such as a modem or network interface card to facilitate exchange of data with external computers via a network 44 (e.g. an Ethernet connection, a digital subscriber line (DSL), a telephone line, coaxial cable, a cellular telephone system, etc.).

Typically, the portable computer also includes one or more mass storage devices 46 for storing software and data. Examples of such mass storage devices include floppy disk drives, hard drive disks, compact disk drives and digital versatile disk (DVD) drives.

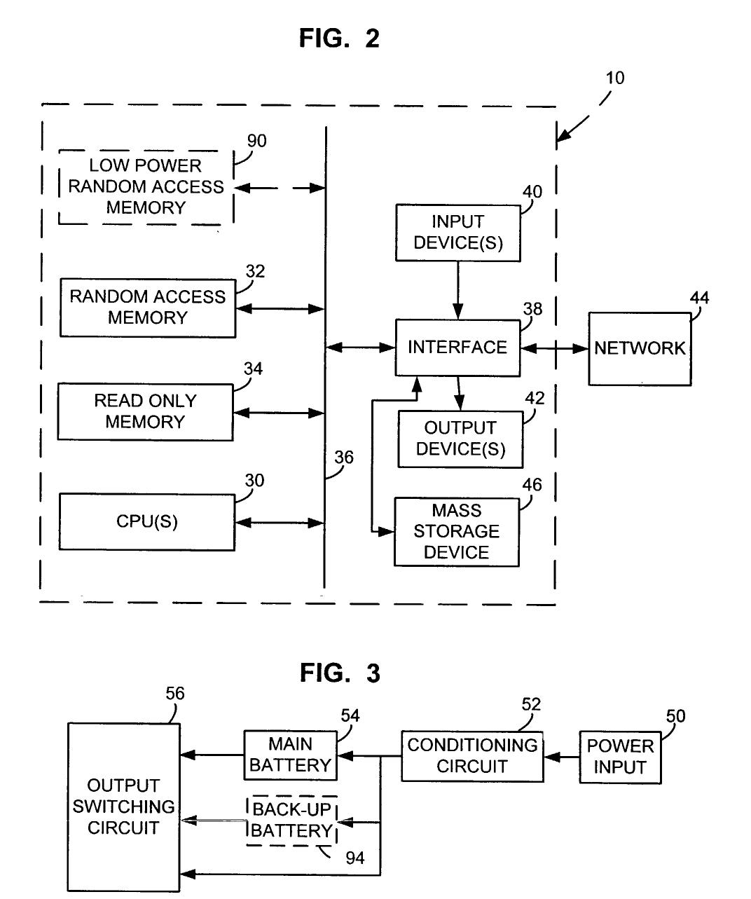

The portable computer 10 also includes a conventional power supply circuit. An example of such a circuit is schematically illustrated in FIG. 3. The illustrated power supply circuit includes a power input 50 for connecting the portable computer 10 to a commercial AC power source. It also includes a power conditioning circuit 52 for rectifying, smoothing and stepping the input voltage received at the power input 50 to a desired DC voltage level. The DC voltage developed by the power conditioning circuit 52 is provided to a main battery 54, and an output switching circuit 56. When the switching circuit 56 detects the presence of a DC voltage output by the power conditioning circuit 52, it connects the conditioning circuit 52 to supply the components of the portable computer 10 with power by the external power supply connected to input 50. When no voltage is output by the conditioning circuit 52, the switching circuit 56 connects the main battery 54 to supply the components of the portable computer 10 with power from the main battery 54. The main battery 54 is recharged by connecting the portable computer 10 to an external power source via input 50 while the computer 10.

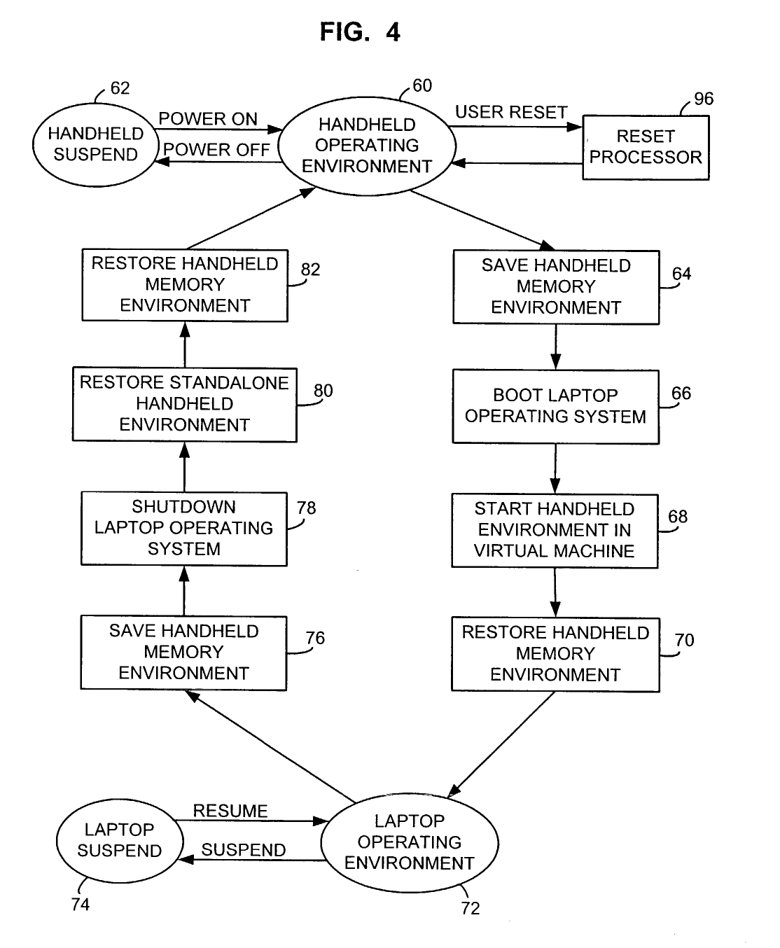

As explained briefly above, the portable computer 10 is programmed to have multiple operating states in which one of two different operating systems are executed in a hierarchical relationship. An example of that hierarchical relationship is shown in FIG. 4.

When a user powers up the illustrated portable computer 10, it enters the handheld operating environment 60 provided by the handheld operating system (e.g., Windows CE). In this state, the portable computer 10 functions as a handheld device such as a PDA and the laptop operating system is not loaded or executed. As is usually the case with a PDA, if no actions are taken for a predetermined time period, or if the user directs the computer 10 to power down from the handheld operating environment 60, the computer 10 enters the very low power consumption handheld suspend state 62. As is conventional, the computer 10 will wake from the handheld suspend state 62 to the handheld operating environment 60 whenever the user enters a command to wake the device or whenever a self-waking event occurs (e.g., a scheduled time and/or date arrives which requires an alarm to sound).

As stated above, the handheld operating system of the illustrated device is modified to provide a user with an option to request boot up of a laptop operating system. As shown in FIG. 4, when a user enters such a request, the settings associated with the handheld memory environment are saved to a non-volatile memory resource such as the mass storage device and the handheld operating system is shut down (block 64). The laptop operating system is then booted up in a conventional fashion (block 66).

In the illustrated device, the laptop operating system is also modified to run the handheld operating system in a virtual machine. In particular, as part of the laptop operating system boot-up procedure, the laptop operating system loads the handheld operating system for execution in a virtual machine (block 68). When the handheld operating system is so loaded, it restores the settings of the handheld operating environment 60 from the non-volatile memory (block 70) so that both the laptop operating environment 72 and the handheld operating environment are available to the user when the laptop operating system is executing.

In many instances, the laptop operating system and handheld operating system will have overlapping applications that utilize the same type(s) of data. For example, both systems may have a calendar program, a contact list, etc. In such instances, the illustrated handheld and laptop operating systems are adapted to automatically synchronize the overlapping data when a change is made, such that both the overlapping data in the laptop and handheld environments remain synchronized. By way of example, if a user changes the telephone number of a person in a contact list in an application running in the handheld environment provided in the virtual machine, that telephone number is automatically changed in the same way in the corresponding place in the laptop operating environment. Preferably, this synchronization of data occurs (or is recorded for later synchronization) whether the change is made via: (1) an application run by the laptop operating system, (2) an application run by the handheld operating system running in a virtual machine, (3) an application run by the handheld operating system running when the laptop operating system is not loaded and (4) when a synchronizable event is sent from a remote device across a network (e.g., an email is received, a calendar appointment is made via the remote device, etc.).

As will be appreciated by those of ordinary skill in the art, data synchronization can be achieved in any number of ways. One way is to maintain a table correlating data fields in the handheld operating environment to data fields in the laptop operating environment. Whenever a change is made to a data field identified in the table, the change is recorded in the table. Thus, when the operating system that was not involved in the data change becomes active (e.g., the user changes operating environments), the newly activated system checks the table for modifications, updates its corresponding data field(s) with the changed data and clears the table. In this way, data synchronization between the handheld and laptop operating systems is confirmed and/or achieved whenever a user changes from the laptop operating environment to the handheld operating environment and vice versa.

Returning to FIG. 4, in addition to the handheld operating environment 60, the handheld suspend mode 62, and the laptop operating environment 72, the illustrated portable computer 10 is also provided with a laptop suspend mode 74. The laptop suspend mode 74 is a low power mode that the portable computer 10 enters to conserve battery life. The laptop suspend mode 74 is entered from the laptop operating environment 72 when no user input has been detected for a predetermined length of time. The portable computer 10 exits the laptop suspend mode 74 when a wake-up event occurs (e.g., any user input or a prescheduled event occurs).

As mentioned above, the laptop operating system of the illustrated computer 10 is programmed to boot-up the handheld operating system in response to a user command. In the illustrated example, that user command is a request to power down the computer. Whenever such a request is received, the handheld operating environment is closed along with the virtual machine within which it was running, and the handheld operating settings are saved to non-volatile memory (block 76). The laptop operating system is then shut down (block 78). Next, the handheld operating system is booted up (block 80) and the handheld memory settings are restored to memory (block 82) to set up the handheld operating environment 60. As will be appreciated by persons of ordinary skill in the art, the portable computer 10 does not actually shut completely off in response to a shut down command in the laptop operating environment 72. Instead, the portable computer 10 reconfigures itself into the lower power handheld operating environment 60. If no user input is received within a predetermined time period of entering the handheld operating environment 60, the portable computer 10 enters the even lower power handheld suspend mode 62. The predetermined time period may optionally be zero such that the computer 10 moves directly into the handheld suspend mode 62 upon shutdown of the laptop operating system.

Because when the laptop operating system is running, the handheld operating system is also running in the virtual machine, persons of ordinary skill in the art will appreciate that the computer 10 may be programmed to go from the laptop suspend mode 74 to the handheld operating environment (without entering the laptop operating environment 72) in response to a user request to do so. When such an event occurs, the user can return to the laptop operating environment 72 by entering a suitable request to do the same in the handheld operating environment executing in the virtual machine.

As mentioned above, in the illustrated device, the microprocessor of the CPU 30 employs a modified version of Geyserville technology such that, when the portable computer 10 is (1) running the laptop operating system and (2) is connected to an external power source via input 50, the microprocessor operates in a first power mode at a first frequency and a first voltage level. When the portable computer 10 is running the laptop operating system and is not connected to an external power source, the microprocessor operates in a second power mode at a second frequency and a second voltage level which are respectively below the first frequency and first voltage level of the first power mode, to conserve battery power and prolong operating time. Furthermore, when the portable computer 10 is running the handheld operating system to provide the handheld operating environment 60 and not running the laptop operating system, the microprocessor 30 operates at a third frequency and a third voltage level which are respectively below the second frequency and the second voltage level of the second power mode to further conserve power and operate the computer 10 at speeds expected by the applications of the handheld operating environment. (Optionally, the third frequency/third voltage level can be used when commercial power is available and a fourth frequency/fourth voltage level could be used when operating the handheld operating system on battery power).

In other words, the portable computer 10 operates at a first power level in the laptop operating environment, a second power level below the first power level during the laptop suspend mode, a third power level below the first power level during the handheld operating mode (as stated above, the third power level could optionally be split into two power levels; one when commercial power is available and another lower level when no commercial power is supplied), and a fourth power level below the third power level during the handheld suspend mode. The handheld suspend mode is an ultra-low power mode as it is intended to be an “off state” of the portable computer such that the computer 10 can automatically wake up in response to a predefined scheduled event (e.g., appointment alerts, reminders, etc. that are typical of PDA's).

In the illustrated example, each of the laptop operating system and the handheld operating system has access to the random access memory 32. To avoid conflicts between the systems, the random access memory 32 is partitioned into a first memory segment which is allocated to the laptop operating system and a second memory segment which is allocated to the handheld operating system. For example, if the random access memory 32 has 128 MB (megabytes), 32 MB may be partitioned to the handheld operating system and the remainder may be allocated to the laptop operating system. The portable computer 10 may also be programmed to dynamically change or be manually reconfigured into different memory allocations to suit the user.

Instead of the partitioning arrangement discussed above, the portable computer 10 can optionally be provided with a second bank of random access memory 90 as shown in FIG. 2. This second random access memory 90 is preferably dedicated to use by the handheld operating system. It is preferably of a type that consumes low levels of power (e.g., flash memory or battery back SRAM) and is used in place of partitioning to reduce battery power consumption. When a second random access memory 90 is provided in this manner, the laptop operating system would preferably use the first memory bank 34. The first memory 34 may be of a type that consumes more power than the second memory 90 (e.g., SDRAM or RDRAM).

To avoid data loss in the event of a failure in the main battery 54, the portable computer 10 is preferably provided with a back-up battery 94. As shown in FIG. 3, the back-up battery 94 is connected in parallel with the main battery 54 between the conditioning circuit 52 and the output switching circuit 56 and is preferably only connected for use via the output switching circuit 56 when (1) insufficient power is available from (a) the main battery 54 or (b) the AC power source via conditioning circuit 52 or (2) the main battery 54 is being charged. The back-up battery 94 ensures that changes made in the handheld operating environment since the last synchronization will not be lost in the event of a failure in the main battery 54. The back-up battery 94 can be implemented by, for example, a lithium ion battery.

In the event of a failure in both the main battery 54 and the back-up battery 94, which results in a loss of data in the random access memory 32 or 90, the last synchronized data state can be restored from the mass storage device 46 of the portable computer 10. Known handheld devices such as PDA's lose all content in the event of such a failure so that a full restore procedure must be performed from an external backup device.

Preferably, the portable computer 10 is also provided with a reset switch. As shown in FIG. 4, actuation of the reset switch initiates a true, power-on reset to the microprocessor in the CPU 30 (block 96). Upon completion of the reset procedure (block 96), the handheld operating system is booted-up to initiate the handheld operating environment 60.

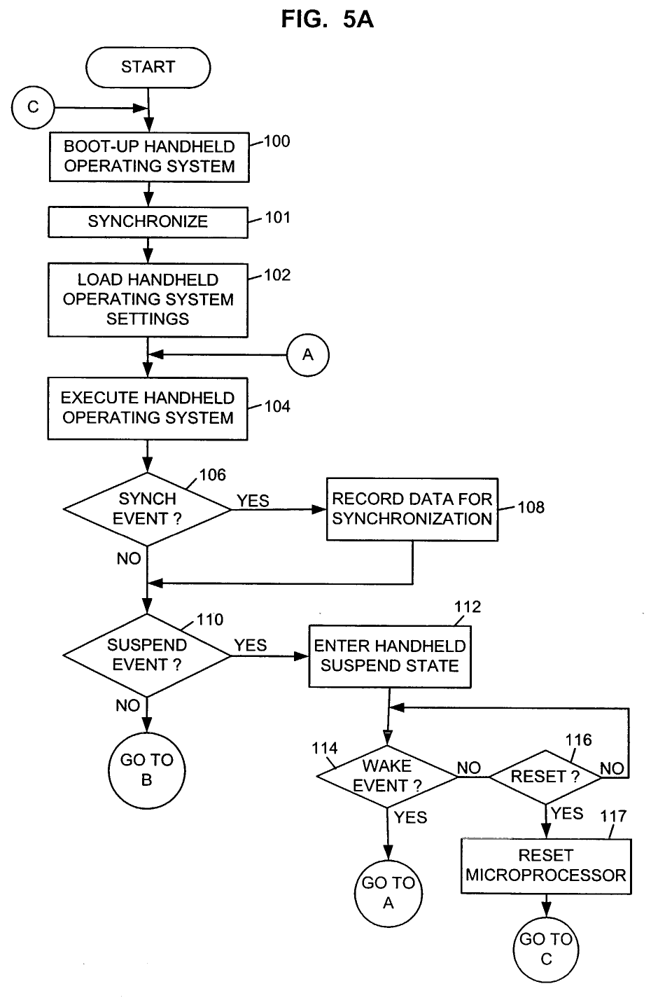

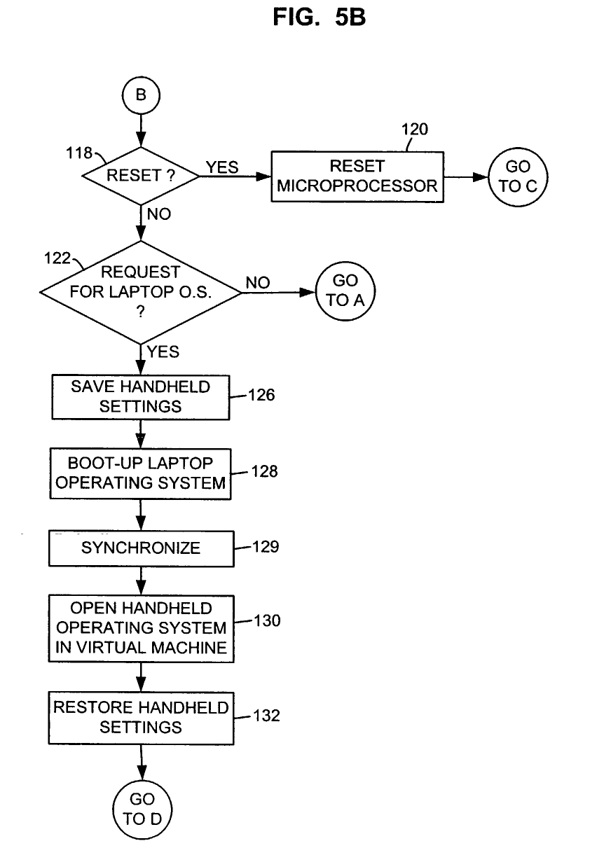

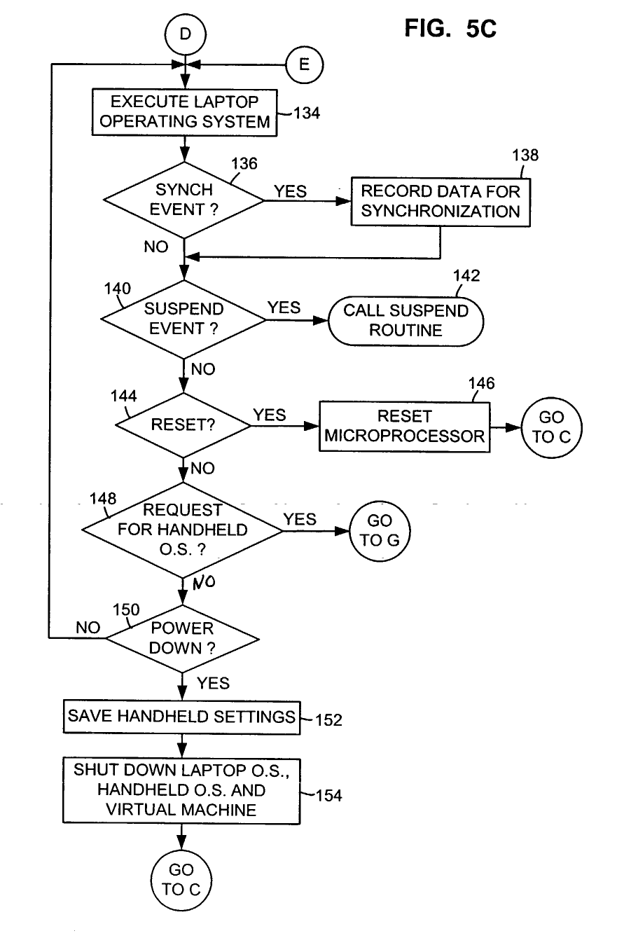

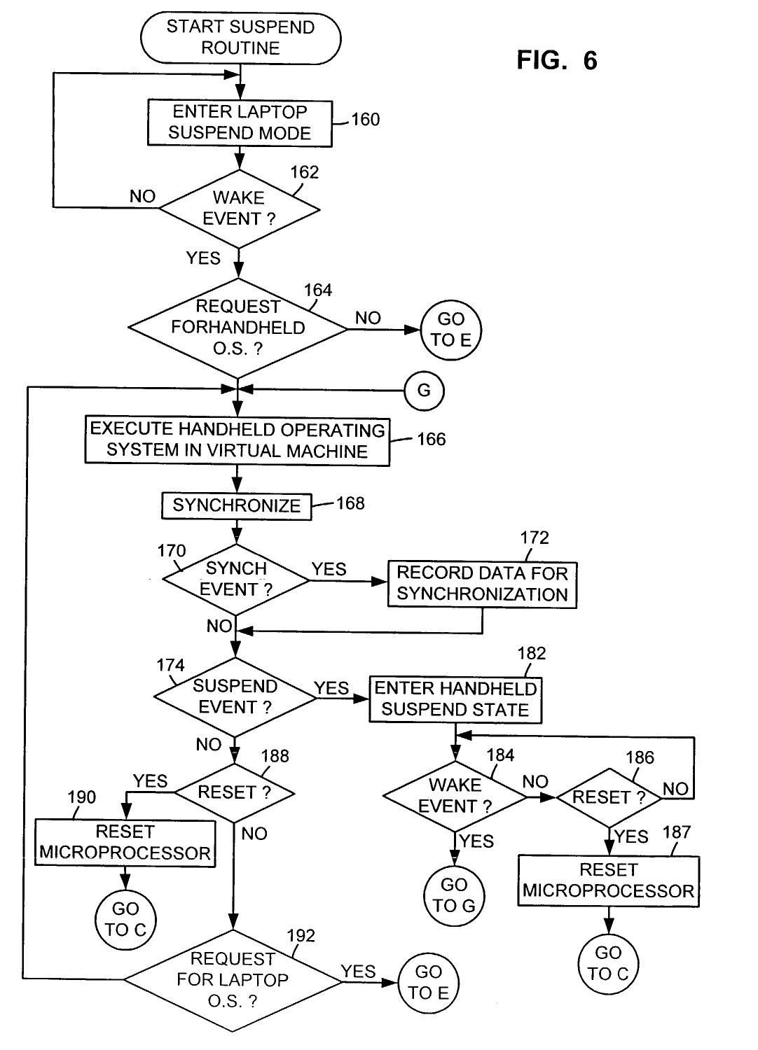

One possible implementation of the computer program executed by the portable computer 10 to provide the environments reflected in FIG. 4 is illustrated in FIGS. 5A-5C and 6. Persons of ordinary skill in the art will appreciate that the computer program can be implemented in any of many different ways utilizing any of many different programming codes stored on any of many tangible mediums such as a volatile or nonvolatile memory or other mass storage device, (e.g., a floppy disk, a CD, a DVD). Thus, although a particular order of steps is illustrated in FIGS. 5A-5C and 6, persons of ordinary skill in the art will appreciate that these steps can be performed in other temporal sequences. Again, the flow chart is merely provided as an example of one way to program the computer 10 to execute hierarchically related operating systems.

Assuming that the computer 10 is being reset via the reset switch or turned on for the first time (e.g., after a power failure), the handheld operating system is first booted up (block 100 of FIG. 5A). Upon completion of the boot-up operation, the handheld operating system checks for any entries in the synchronization table that indicate a synchronization event occurred while the handheld system was dormant (e.g., a change as made via an application executed by the laptop operating system). If such an entry is found, the corresponding data change is made in the handheld data (block 101) to maintain synchronization between the operating systems.

Next, the settings of the handheld operating system are loaded into the random access memory 32 or 90 (block 102). With the settings loaded into memory, the handheld operating system is executed to provide the handheld operating environment (block 104). As discussed above, the handheld operating environment is a low power mode that makes available the handheld applications and handheld data typically found in a handheld computer such as a PDA.

The handheld operating system detects synchronization events during operation. Synchronization events can be of any desired type, but will involve a change in data that can be reflected in both the laptop operating system and the handheld operating system data. For example, a synchronizable event could include scheduling an event in a calendar, the arrival of an event previously noted in a calendar, changing data in a contact list, changing data in a To Do list, etc. When a synchronization event is detected (block 106), control proceeds to block 108. At block 108, the change in data is recorded for later use in synchronization (e.g., it is noted in a synchronization table as explained above).

If no synchronization event is detected (block 106) or after the synchronization data is recorded (block 108), control proceeds to block 110.

At block 110, the operating system determines whether a suspend event has occurred. A suspend event can be of any desired type. However, in the illustrated example, a suspend event is a failure to receive an input from a user or to detect an occurrence of a prescheduled event (e.g., arrival of a scheduled date or time) within a predetermined time frame (e.g., within two minutes). If a suspend event is detected (block 110), the handheld suspend state is entered (block 112). As discussed above, the handheld suspend state is an ultra-low power mode that is available on handheld computers today for “turning off” the device to provide better battery longevity. The handheld suspend mode also accommodates instant-on resume to the handheld operating environment as shown in FIG. 5A. In particular, if the handheld suspend state is entered (block 112), the portable computer 10 reduces its functions to save power (e.g., reduces the operating voltage and frequency of the microprocessor shuts down the display device, etc.) and awaits occurrence of a wake-up event (block 114) or a reset command (block 116). A wake-up event can be any desired event such as a user input, arrival of a scheduled event, etc. When a wake-up event occurs, control proceeds to block 104 where the handheld operating system environment is immediately made available to the user. If no wake-up event has been detected (block 114), control proceeds to block 116 where it is determined if the reset switch has been actuated. If the reset switch has been actuated (block 116), the microprocessor 30 is reset as explained above (block 117) and control returns to block 100 where the handheld operating system is booted up. Control will loop through blocks 114-116 until a wake-up event occurs or until the reset switch is actuated.

If no suspend event is detected (block 110), control proceeds to block 118 (FIG. 5B). At block 118, if the reset switch has been actuated, the microprocessor is reset (block 120) and control returns to block 100 where the handheld operating system is booted up as explained above.

Assuming the reset switch has not been actuated (block 118), control proceeds to block 122. At block 122, the microprocessor 30 determines whether a request for the laptop operating system has been received. If no such request has been received (block 122), control proceeds to block 104. Control then continues to loop through blocks 104-122 until the laptop operating system is requested or a reset event occurs.

Assuming that the user has requested the laptop operating system (block 122), control proceeds to block 126. At block 126, the settings associated with the handheld operating environment are saved in non-volatile memory (e.g., written to the hard drive 46), and the handheld operating system is closed. The laptop operating system is then booted up (block 128). At block 129 the laptop operating system checks the synchronization table to see if any change was made in the handheld operating environment that requires a data change in the laptop operating environment (e.g., the change of a phone number in a contact list, etc.). If such a change occurred, a corresponding data change is made in the corresponding memory location for the laptop operating system to thereby synchronize the overlapping handheld and laptop operating systems (block 129).

After any required synchronization is completed (block 129), the handheld operating system is re-booted in a virtual machine operated by the laptop operating system (block 130). After rebooting the handheld operating system in the virtual machine, the settings of the handheld operating system stored at block 126 are retrieved to the random access memory at block 132.

With the laptop operating system booted and the handheld operating system running in a virtual machine, control proceeds to block 134 (FIG. 5C) where the laptop operating system begins operation according to its normal procedures. The laptop operating system is modified to accommodate the availability of the handheld operating environment as explained below. In particular, the laptop operating system periodically checks to see if a synchronization event has occurred (block 136). When a synchronization event occurs (block 136), the laptop operating system may record the data change in the synchronization table as explained above to permit later synchronization between the laptop operating environment and the handheld operating environment (block 138). Preferably, however, since the handheld operating system is operating in a virtual machine, data synchronization between the operating system is immediately performed rather than waiting for the next time the user switches to the handheld operating system.

If no synchronization event occurs at block 136, or after the synchronization data is recorded or the data is synchronized (block 138), control proceeds to block 140. At block 140, the laptop operating system determines whether a suspend event has occurred. As explained above, a suspend event can be any desired event such as expiration of a predetermined time period during which no user input is received and no preprogrammed alarm or event occurs. If a suspend event has occurred, control proceeds to block 142 where the suspend routine described in FIG. 6 is called. If no suspend event is detected (block 140), control proceeds to block 144.

At block 144, the laptop operating system determines whether the reset switch has been actuated. If the reset switch has been actuated, the microprocessor is reset (block 146) and control returns to block 100 (see FIG. 5A) where the handheld operating system is booted up. If the reset switch has not been actuated (block 144), control proceeds to block 148. At block 148, the laptop operating system determines whether a request for the handheld operating system has been received. If such a request has been received (block 148), control proceeds to block 166 (FIG. 6) where the handheld operating system is executed in the virtual machine routine. If no such request has been received, the laptop operating system determines if a request to power down has been received (block 150). If no such request has been received (block 150), control continues to loop through blocks 134-150 until a suspend event is detected (block 140), until a reset event occurs (block 144), until a request for the handheld operating system is detected (block 148) or a request to power down is received (block 150).

Assuming a request to power down is received (block 150), the settings for the handheld operating environment running in the virtual machine are saved (block 152). Then the handheld operating system, the virtual machine, and the laptop operating system are shut down (block 154). Control then returns to block 100 (FIG. 5A) where the handheld operating system is booted up as explained above.

Returning for the moment to block 140 of FIG. 5C, if, when executing the laptop operating system, a suspend event is detected (block 140), a suspend routine is called (FIG. 6). When the suspend routine is called, the laptop operating system enters the laptop suspend mode (block 160). As explained above, the laptop suspend mode is a low power stand-by mode that is available in conventional laptop computers for saving the state of the laptop operating environment to provide better battery longevity. In the laptop suspend mode, the functions of the portable computer are reduced. However, the microprocessor 30 continues to monitor for a wake-up event (block 162). As explained above, a wake up event can be any desired event, such as a user input and/or a preprogrammed event (e.g., a scheduled event alert). If a wake up event occurs (block 162), the microprocessor determines whether the wakeup event is a request for the handheld operating environment received from the user (block 164). If the wake-up event is such a request control proceeds to block 166. If the wake-up event is not a request for the handheld operating system (block 164), control returns to block 134 (FIG. 5C) where the laptop operating environment is again made available to the user.

Returning for the moment to block 162 (FIG. 6), if no wake-up event has occurred, control returns to block 160. Control continues to loop through blocks 160-162 until a wake up event occurs (block 162).

Assuming a request for the handheld operating environment has been received in the laptop suspend mode or the laptop operating environment (block 164 of FIG. 6 or block 148 of FIG. 5C), the portable computer 10 is immediately able to provide the user with access to the handheld operating environment via the handheld operating system executing in the virtual machine (block 166). At block 168, the handheld operating system may optionally check the synchronization table to see if any change was made in the laptop operating environment that requires a data change in the handheld operating environment (e.g., the change of a telephone number in a contact list, etc.) If such a change occurs, a corresponding data change is made in the corresponding memory location for the handheld operating system to thereby synchronize the overlapping handheld and laptop operating system (block 168). (However, as stated above, data synchronization between the laptop system and the handheld system preferably occurs immediately after such an event is detected, rather than waiting for the user to switch between the systems as shown in the drawings.)

After any required synchronization is complete, the handheld operating system determines if a synchronization event has occurred (block 170). If a synchronization event is detected (block 170), the handheld operating system may optionally record the data associated with the synchronization triggering event in the synchronization table (block 172). (However, as explained above, it is preferred that the synchronization of data be actually performed at block 172 (i.e., the laptop data updated) rather than merely recorded for subsequent change.) After recording the synchronization data or synchronizing the data (block 172) or if no synchronization event is detected (block 170) control proceeds to block 174.

At block 174, the handheld operating system determines whether a suspend event has occurred. If a suspend event is detected (block 174), the handheld suspend state is entered (block 182). As discussed above, the handheld suspend state accommodates instant-on resume to the handheld operating environment. In particular, if the handheld suspend state is entered (block 182), the portable computer 10 reduces its functions to save power and awaits occurrence of a wake-up event (block 184) or reset command (block 186). When a wake-up event occurs, control proceeds to block 166 where the handheld operating system environment is immediately made available to the user via the virtual machine. If no wake-up event has been detected (block 184), control proceeds to block 186 where it is determined if the reset switch has been actuated. If the reset switch has been activated (block 186), the microprocessor 30 is reset as explained above (block 187) and control returns to block 100 (FIG. 5A) where the handheld operating system is booted up. Control will loop through blocks 184-186 until a wake-up event occurs or until the reset switch is actuated.

If no suspend event is detected (block 174), control proceeds to block 188. At block 188, if the reset switch has been actuated, the microprocessor is reset (block 190) and control returns to block 100 (FIG. 5A) where the handheld operating system is booted up as explained above.

Assuming the reset switch has not been actuated (block 188), control proceeds to block 192. At block 192, the microprocessor 30 determines whether a request for the laptop operating system has been received. If no such request has been received (block 192), control proceeds to block 166. Control then continues to loop through blocks 166-192 until the laptop operating system is requested or a reset event occurs.

If a request for the laptop operating system has been entered (block 192), control returns to block 134 (FIG. 5C). Otherwise, control continues to loop through 166-192 as explained above.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. In combination, an apparatus comprising:
a portable computer;
a handheld operating system stored in the portable computer to operate the portable computer as a handheld device; and a laptop operating system stored in the portable computer to operate the portable computer as a laptop computer, the laptop operating system being responsive to a first command to boot-up the handheld operating system, the handheld operating system being responsive to a second command to boot-up the laptop operating system.

2. An apparatus as defined in claim 1 wherein the first command is a command to close the laptop operating system.

3. An apparatus as defined in claim 1 wherein the handheld operating system executes in a virtual machine while the laptop operating system is operating.

4. An apparatus as defined in claim 1 wherein the handheld operating system and the laptop operating system cooperate to synchronize predefined data.

5. An apparatus as defined in claim 1 wherein the portable computer includes:
a first random access memory for use by the laptop operating system; and
a second random access memory for use by the handheld operating system, the second random access memory having a lower power requirement than the first random access memory.

6. An apparatus as defined in claim 1 wherein the portable computer has a first mode and a second mode when executing the laptop operating system, a processor of the portable computer operates at a first frequency and a first voltage level in the first mode, and the processor of the portable computer operates at a second frequency and a second voltage level in the second mode.

7. An apparatus as defined in claim 6 wherein the processor of the portable computer operates at a third frequency and a third voltage level when executing the handheld operating system.

8. An apparatus as defined in claim 7 wherein the portable computer has a standby mode for suspending operation of the handheld operating system.

9. An apparatus as defined in claim 6 wherein the first mode occurs when the portable computer is powered by a power supply and the second mode occurs when the portable computer is powered by an internal battery.

10. An apparatus as defined in claim 7 wherein the second frequency is lower than the first frequency and the third frequency is lower than the second frequency.

11. An apparatus as defined in claim 10 wherein the second voltage is lower than the first voltage and the third voltage is lower than the second voltage.

12. An apparatus as defined in claim 1 wherein the portable computer includes a random access memory which is partitioned into a first memory segment and a second memory segment, the first memory segment being allocated to the laptop operating system and the second memory segment being allocated to the handheld operating system.

13. An apparatus as defined in claim 1 wherein the portable computer further comprises:
a main battery to power the portable computer; and
a back-up battery to power the portable computer in the event of a failure of the main battery.

14. An apparatus as defined in claim 1 wherein the portable computer further comprises a hard disk drive, and, in the event of a power failure resulting in data loss, data associated with a last synchronized state of the handheld operating system is restored from the hard disk drive upon return of power.

15. An apparatus as defined in claim 1 wherein the portable computer further comprises a reset switch, wherein actuating the reset switch causes the portable computer to reset a microprocessor and causes the handheld operating system to boot-up.

16. An apparatus as defined in claim 1 wherein the laptop operating system includes a laptop operating environment mode and a laptop suspend mode, and the handheld operating system includes a handheld operating environment mode and a handheld suspend mode.

17. An apparatus as defined in claim 16 wherein the laptop operating mode has a first power mode wherein the portable computer is powered from a commercial power supply and a second power mode wherein the portable computer is powered by a battery.

18. An apparatus as defined in claim 16 wherein a processor of the portable computer operates at a first power level during the laptop operating mode, a second power level during the laptop suspend mode, a third power level during the handheld operating mode and a fourth power level during the handheld suspend mode.

19. An apparatus as defined in claim 18 wherein the processor of the portable computer utilizes less power at the third power level than at the first power level and the processor of the portable computer utilizes less power at the fourth power level than at the third power level.

20. An apparatus as defined in claim 18 wherein the processor of the portable computer utilizes less power at the second power level than at the first power level and the processor of the portable computer utilizes less power at the fourth power level than at the second power level.

21. An apparatus as defined in claim 16 wherein a handheld software application and handheld data are available when the microprocessor is in the handheld operating mode.

22. An apparatus as defined in claim 16 wherein a first set of hardware features are available during the laptop operating mode and the first set of hardware features are unavailable during the handheld operating mode.

23. An apparatus as defined in claim 16 wherein the portable computer transitions from the handheld suspend mode to the handheld operating mode upon receipt of a signal.

24. An apparatus as defined in claim 16 wherein the portable computer transitions from the laptop suspend mode to the handheld operating mode in response to a first input signal.

25. An apparatus as defined in claim 24 wherein the portable computer transitions from the handheld operating mode to the laptop operating mode in response to a second input signal.

26. An apparatus as defined in claim 16 wherein the portable computer transitions from the handheld operating mode to the laptop operating mode in response to an input signal.

27. An apparatus as defined in claim 16 wherein the portable computer transitions from the laptop operating mode to the laptop suspend mode after a predetermined time without receipt of an input signal.

28. An apparatus as defined in claim 16 wherein the portable computer transitions from the handheld operating mode to the handheld suspend mode after a predetermined time without receipt of an input signal.

29. A portable computer comprising:
a memory storing a laptop operating system and a handheld operating system; and
a processor in communication with the memory, the laptop operating system being responsive to a command to power down to cause the processor to boot-up the handheld operating system.

30. A portable computer as defined in claim 29 wherein the handheld operating system and the laptop operating system cooperate to synchronize predefined data.

31. A portable computer as defined in claim 30 wherein the processor has a first mode and a second mode when executing the laptop operating system, the processor operates at a first frequency and a first voltage level in the first mode, and the processor operates at a second frequency and a second voltage level in the second mode.

32. A portable computer as defined in claim 31 wherein the processor operates at a third frequency and a third voltage level when executing the handheld operating system.

33. A portable computer as defined in claim 32 wherein the processor has a standby mode for suspending operation of the handheld operating system.

34. A portable computer as defined in claim 31 wherein the first mode occurs when the portable computer is powered by a commercial power supply and the second mode occurs when the portable computer is powered by an internal battery.

35. A portable computer as defined in claim 32 wherein the second frequency is lower than the first frequency and the third frequency is lower than the second frequency.

36. A portable computer as defined in claim 35 wherein the second voltage is lower than the first voltage and the third voltage is lower than the second voltage.

37. For use with a computer including a processor, an input device, an output device and a memory, a computer program stored on a tangible medium comprising:
a handheld operating system configured to execute on the processor and to provide an opportunity to boot-up a laptop operating system to execute on the processor.

38. A computer program as defined in claim 37 wherein the handheld operating system executes in a virtual machine while the laptop operating system is operating.

39. A computer program as defined in claim 37 wherein the handheld operating system and the laptop operating system cooperate to synchronize predefined data.

40. A computer program as defined in claim 37 wherein a handheld software application and handheld data are available to a user when the handheld operating system is executed.

41. A computer program as defined in claim 37 wherein a first set of hardware features are available to a user when the laptop operating system is executing and the first set of hardware features are unavailable when the handheld operating system is executing.

42. For use with a computer including a processor, an input device, an output device and a memory, a computer program stored on a tangible medium comprising:
a laptop operating system configured to execute on the processor and to cause the processor to boot-up a handheld operating system in response to a power-down signal.

43. A computer program as defined in claim 42 wherein the handheld operating system and the laptop operating system cooperate to synchronize predefined data.

44. A computer program as defined in claim 42 wherein a handheld software application and handheld data are available to a user when the handheld operating system is executed.

45. A computer program as defined in claim 42 wherein a first set of hardware features are available to a user when the laptop operating system is executing and the first set of hardware features are unavailable when the handheld operating system is executing.

46. A portable computer comprising:
a memory storing a laptop operating system and a handheld operating system; and
a processor in communication with the memory, the laptop operating system being configured to execute the handheld operating system in a virtual machine.

47. A portable computer as defined in claim 46 wherein the laptop operating system and the handheld operating system are configured to automatically synchronize in response to a synchronizable event occurring in one of the laptop operating system and the handheld operating system.

48. A portable computer comprising:
a memory storing a laptop operating system and a handheld operating system; and
a processor in communication with the memory, the processor having: (1) a first operating mode wherein the processor operates at a first frequency and a first voltage level, (2) a second operating mode wherein the processor operates at a second frequency and a second voltage level, and (3) a third operating mode wherein the processor operates at a third frequency and a third voltage level.

49. A portable computer as defined in claim 48 wherein the processor executes a laptop operating system in the first operating mode and the second operating mode, and operates a handheld operating system in the third operating mode.

50. A portable computer as defined in claim 49 wherein the processor further includes a fourth operating mode.

51. A portable computer as defined in claim 50 wherein the fourth operating mode is a standby mode for suspending operation of the handheld operating system.

52. A portable computer as defined in claim 48 wherein the first operating mode occurs when the portable computer is powered by an external power supply and the second operating mode occurs when the portable computer is powered by an internal battery.

53. A portable computer as defined in claim 48 wherein the second frequency is lower than the first frequency and the third frequency is lower than the second frequency.

54. A portable computer as defined in claim 53 wherein the second voltage is lower than the first voltage and the third voltage is lower than the second voltage.

55. A portable computer as defined in claim 54 wherein the processor executes a laptop operating system in the first operating mode and the second operating mode, and operates a handheld operating system in the third operating mode.

56. A portable computer as defined in claim 55 wherein the first operating mode occurs when the portable computer is powered by an external power supply and the second operating mode occurs when the portable computer is powered by an internal battery.

57. A portable computer comprising: an input device;
an output device;
a memory storing a laptop operating system and a handheld operating system; and
a processor in communication with the input device, the output device and the memory, the memory including a random access memory which is partitioned into a first memory segment and a second memory segment, the first memory segment being allocated to the laptop operating system and the second memory segment being allocated to the handheld operating system.

58. A computer program as defined in claim 57 wherein the handheld operating system executes in a virtual machine while the laptop operating system is operating.

59. A computer program as defined in claim 57 wherein the handheld operating system and the laptop operating system cooperate to synchronize predefined data.

60. A portable computer comprising:
a first random access memory for use by a laptop operating system;
a second random access memory for use by a handheld operating system, the second random access memory having a lower power requirement than the first random access memory; and
a processor in communication with the first and second memories for selectively operating the handheld operating system and the laptop operating system.

61. A computer program as defined in claim 60 wherein the handheld operating system executes in a virtual machine while the laptop operating system is operating.

62. A computer program as defined in claim 60 wherein the handheld operating system and the laptop operating system cooperate to synchronize predefined data.

63. A portable computer comprising:
an input device;
an output device;
a memory; and
a processor in communication with the input device, the output device and the memory, the processor being programmed to have a laptop operating environment mode, a laptop suspend mode, a handheld operating environment mode, and a handheld suspend mode.

64. A portable computer as defined in claim 63 wherein the laptop operating mode has a first power mode wherein the portable computer is powered from a commercial power supply and a second power mode wherein the portable computer is powered by a battery.

65. A portable computer as defined in claim 63 wherein the processor operates at a first power level during the laptop operating mode, a second power level during the laptop suspend mode, a third power level during the handheld operating mode and a fourth power level during the handheld suspend mode.

66. A portable computer as defined in claim 65 wherein the processor utilizes less power in the third power mode than in the first power mode and the processor utilizes less power in the fourth power mode than in the second power mode.

67. A portable computer as defined in claim 65 wherein the processor utilizes less power in the second power mode than in the first power mode and the processor utilizes less power in the fourth power mode than in the second power mode.

68. A portable computer as defined in claim 63 wherein handheld software applications and data are available when the processor is in the handheld operating mode.

69. A portable computer as defined in claim 63 wherein a first set of hardware features are available during the laptop operating mode and the first set of hardware features are not available during the handheld operating mode.

70. A portable computer as defined in claim 63 wherein the processor is programmed to transition from the handheld suspend mode to the handheld operating mode upon receipt of an input signal.

71. A portable computer as defined in claim 63 wherein the processor is programmed to transition from the laptop suspend mode to the handheld operating mode in response to a first input signal.

72. A portable computer as defined in claim 71 wherein the processor is programmed to transition from the handheld operating mode to the laptop operating mode in response to a second input signal.

73. A portable computer as defined in claim 63 wherein the processor is programmed to transition from the handheld operating mode to the laptop operating mode in response to an input signal.

74. A portable computer as defined in claim 63 wherein the processor is programmed to transition from the laptop operating mode to the laptop suspend mode after a predetermined time without receipt of an input signal.

75. A portable computer as defined in claim 63 wherein the processor is programmed to transition from the handheld operating mode to the handheld suspend mode after a predetermined time without receipt of an input signal.

76. A method of operating a portable computer comprising:
executing a handheld operating system;
detecting a request to boot-up a laptop operating system;
saving handheld operating environment memory settings; and
booting-up the laptop operating system.

77. A method as defined in claim 76 further comprising:
executing the handheld operating system in a virtual machine after booting-up the laptop operating system; and
restoring the handheld operating environment memory settings.

78. A method as defined in claim 77 wherein executing the handheld operating system in the virtual machine occurs while the laptop operating system is running.

79. A method as defined in claim 76 further comprising:
while executing the handheld operating system, detecting a power down event; and
responding to the power down event by entering a handheld suspend mode.

80. A method as defined in claim 79 further comprising:
while in the handheld suspend mode, detecting a power up event; and
responding to the power up event by entering a handheld operating environment.

81. A method as defined in claim 76 further comprising:
detecting a reset event; and
responding to the reset event by:
resetting a processor; and
automatically booting the handheld operating system.

82. A method of operating a portable computer comprising:
executing a laptop operating system;
detecting a request to power down the laptop operating system; and
booting-up a handheld operating system.

83. A method as defined in claim 82 further comprising:
executing the handheld operating system in a virtual machine while executing the laptop operating system.

84. A method as defined in claim 83 further comprising, in response to the request to power down the laptop operating system:
saving handheld operating environment memory settings;
booting the handheld operating system; and
restoring the handheld operating environment.

85. A method as defined in claim 82 further comprising:
while executing the laptop operating system, detecting a power down event; and
responding to the power down event by entering a laptop suspend mode.

86. A method as defined in claim 85 further comprising:
executing the handheld operating system in a virtual machine while executing the laptop operating system.

87. A method as defined in claim 86 further comprising:
while in the laptop suspend mode, detecting a request to access a handheld operating environment associated with the handheld operating system; and
entering the handheld operating environment.

88. A method as defined in claim 87 further comprising:
while in the handheld operating environment, detecting a request to enter a laptop operating environment associated with the laptop operating system; and
entering the laptop operating environment.

89. A method of operating a portable computer comprising:
executing a laptop operating system;
executing a handheld operating system in a virtual machine while executing the laptop operating system;
while executing the laptop operating system, detecting a power down event;
responding to the power down event by entering a laptop suspend mode;
while in the laptop suspend mode, detecting a request to access a handheld operating environment associated with the handheld operating system; and
entering the handheld operating environment.

90. A method as defined in claim 89 further comprising:
while in the handheld operating environment, detecting a request to enter a laptop operating environment associated with the laptop operating system; and
entering the laptop operating environment.
